(19) United States
(12) Patent Application Publication
(10) Pub. No.: US 2018/0324179 A1
(43) Pub. Date: Nov. 8, 2018

(54) METHOD FOR PREVENTING BADUSB ATTACK

(71) Applicant: Hao-Hsun Hou, Taipei City (TW)

(72) Inventor: Hao-Hsun Hou, Taipei City (TW)

(21) Appl. No.: 15/585,149

(22) Filed: May 2, 2017

(51) Int. Cl. H04L 29/06; G06F 21/56; G06F 13/10; G06F 21/85

(52) U.S. Cl. CPC H04L 63/0876; H04L 63/1441; G06F 21/73; G06F 13/105; G06F 21/85; G06F 21/564

(57) ABSTRACT

A method for preventing BadUSB attack from an external USB device to a host computer is disclosed. The method includes the steps of: a) obtaining a device description from a USB (universal serial bus) device; b) judging if the device description is reasonable; c) loading a driver for the USB device when yes in step b); d) filtering a command from the USB device after step c); and e) disabling the USB device when no in step b) or the command filtered in step d) is malicious.

### BACKGROUND OF THE INVENTION

### 1. Technical Field

The invention relates to universal serial bus (USB), particularly to prevention of USB firmware hacking.

### 2. Relates Art

A USB device firmware hack called BadUSB was presented at Black Hat USA 2014 conference, demonstrating how a USB flash drive microcontroller can be reprogrammed to spoof various other device types in order to take control of a computer, exfiltrate data, or spy on the user. Other security researchers have worked further on how to exploit the principles behind BadUSB, releasing at the same time the source code of hacking tools that can be used to modify the behavior of different USB devices.

Robert Fisk provides hardware USB firewall called USG for preventing BadUSB. It is a hardware dongle that sits between a USB port and untrusted USB devices. It will only pass a limited set of instructions and data between the two, not including the instructions used to trigger BadUSB. However, although the USG is effective in preventing BadUSB, it cannot be used for the newest USB type-C. A software firewall will be a much better solution than hardware one, but there is no anti-virus software which can prevent BadUSB attack because the attack program code of BadUSB is hidden in firmware of devices and cannot be scanned by any anti-virus software.

### SUMMARY OF THE INVENTION

An object of the invention is to provide a method for preventing BadUSB attack, which is software and can be used to all types of USB ports without hardware limitations.

To accomplish the above object, the method for preventing BadUSB attack of the invention includes the steps of: a) obtaining a device description from a USB (universal serial bus) device; b) judging if the device description is reasonable; c) loading a driver for the USB device when yes in step b); d) filtering a command from the USB device after step c); and e) disabling the USB device when no in step b) or the command filtered in step d) is malicious.

### BRIEF DESCRIPTION OF THE DRAWINGS

FIG. 1 is a schematic view showing the sequence of the BadUSB in an external USB device attacking a host computer;

FIG. 2 is a flowchart of the invention; and

FIG. 3 is a schematic view of the USB layer firewall (filter driver).

### DETAILED DESCRIPTION OF THE INVENTION

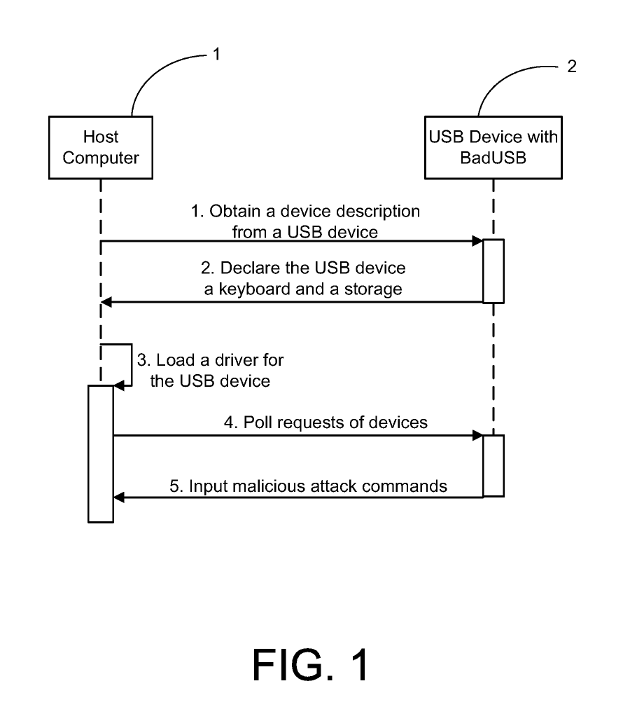

Please refer to FIG. 1, which shows how a host computer is attacked by a USB device with BadUSB. When an external USB (universal serial bus) device 2, such as a USB flash drive, is connected to a host computer 1, such as a desktop or laptop, the first step therebetween is that the host computer 1 obtains a device description from the USB device 2. Such a device description includes a product name, model name, device type, features, etc. For example, a product name may be a keyboard, a model name may be AKB-48, a device type may be an input device, and features may be product identification, vendor identification, a manufacturer, etc.

The second step is that the USB device 2 declares itself to the host computer 1. When the USB device 2 has been injected with BadUSB, the USB device 2 will typically declare itself to be a keyboard and a storage device. In the third step, the host computer 1 loads a corresponding driver for the USB device 2. In the fourth step, the host computer 1 polls requests of all external devices including the USB device 2 with BadUSB. In the final step, the USB device 2 with BadUSB inputs malicious attack commands to the host computer 1. As a result, the host computer 1 is hacked or infected.

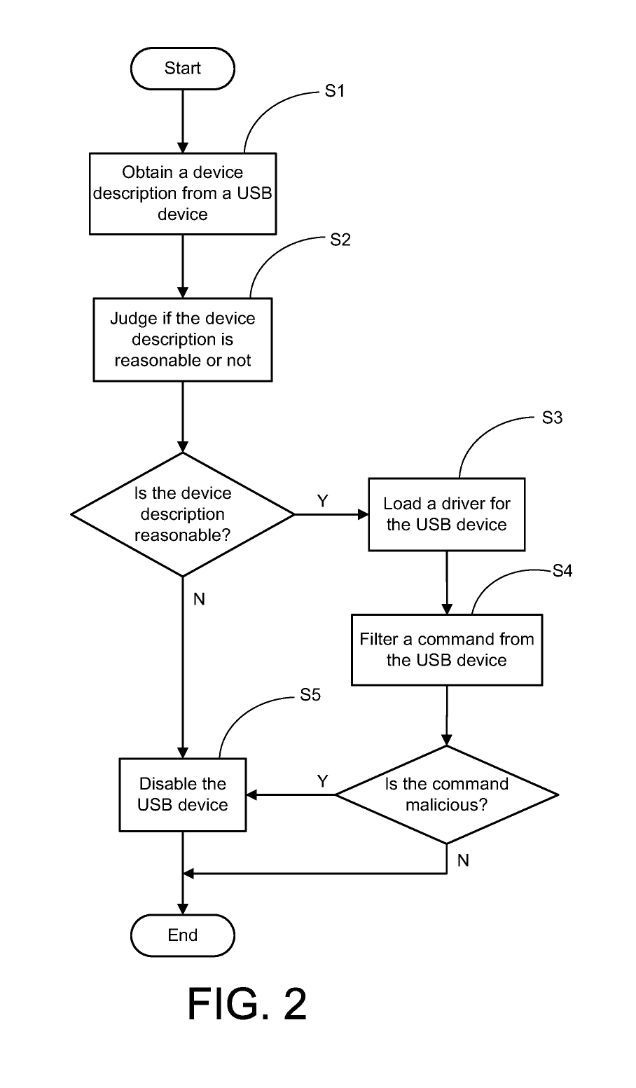

Please refer to FIG. 2, which shows a flowchart of the invention. The invention provides a method for preventing BadUSB attack. The method is implemented to be a software program installed in the host computer 1. In step S1, the host computer 1 obtains a device description from the USB device 2. Step S1 is a routine action after an external USB device has been connected to a computer. In step S2, the software program judges if the device description is reasonable or not. There is a black list database in the software program. Step S2 is performed by comparing the device description with the black list database. For example, a USB device which declares to be both a keyboard and a storage device will be judged unreasonable because a single USB device serving as both an input device and a storage device is unusual and is a typical expression of BadUSB. The black list database has various conditional standards, such as a specifically abnormal combination of two or more types of devices, unknown or questionable manufacturers or product identification, regularized keying in, etc. The USB device 2 will be judged unreasonable if its device description meets the conditional standards of the black list database. This is the first level of detection.

In step S3, the host computer 1 loads a driver for the USB device 2 when yes in step S2. When the USB device 2 passes the first detection, the USB device 2 is preliminary judged safe, so that the USB device 2 can be connected to the host computer 1 by loading its driver. In step S4, the software program filters all commands from the USB device 2 after step S3. Because the USB features are alterable, the abovementioned first detection cannot completely guarantee safety of the USB device 2. When a malicious USB device 2 with BadUSB passes the first detection in step S2 and its driver is loaded in the host computer 1, the malicious USB device 2 will become a keyboard and start inputting malicious commands to the host computer 1. Accordingly, step S4 adopts USB layer firewall to block malicious attack. In other words, step S4 serves as the second level of detection. Such a USB layer firewall is implemented by using a Filter driver, which can be arranged at any level.

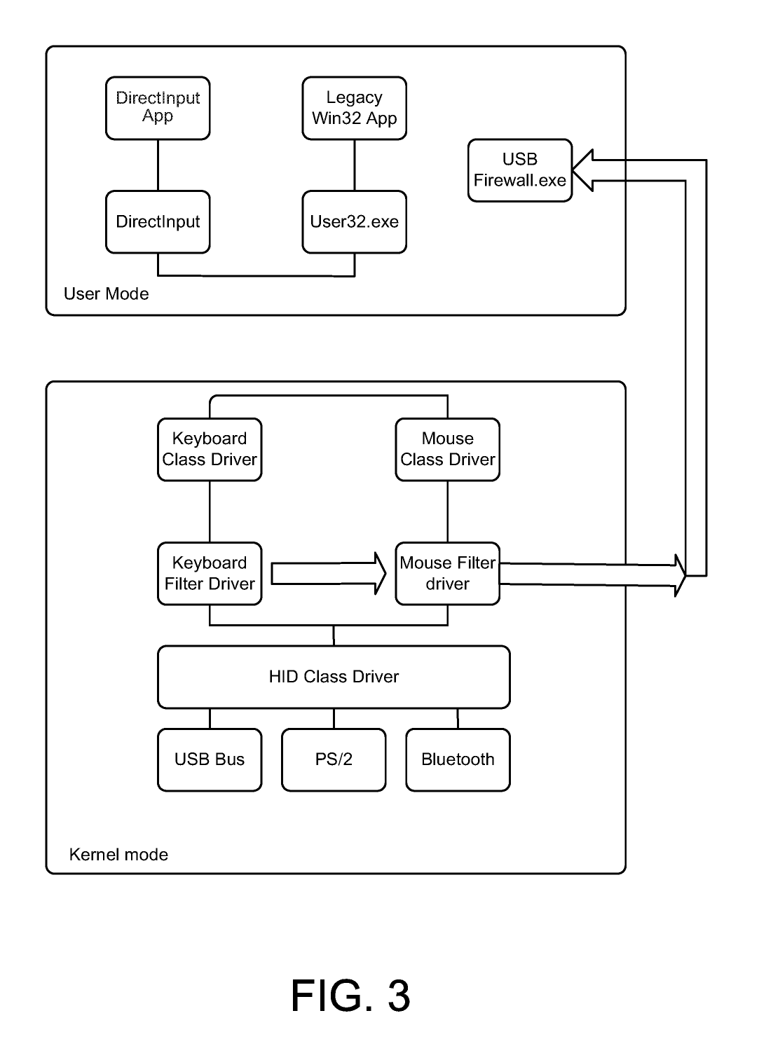

FIG. 3 shows a framework of the USB layer firewall. In detail, in step S4, the software program obtains the data flow from the USB device 2 and then uses the “symbolic link” technology to send key values to the USB firewall program of user mode (USB firewall.exe). After that, the USB firewall program will store the received key values in a buffer and compare the key values with a malicious command database. The key values will be judged malicious if they match a malicious command of the malicious command database. Finally, the software program will disable the USB device 2 when no in step S2 or the command filtered in S4 is judged malicious. That is, the USB device 2 can be blocked to connect the host computer 1 when it fails to pass the first detection in step S2 or the second detection in step S4. As a result, the USB device 2 with BadUSB has no chance to attack the host computer 1.

It will be appreciated by persons skilled in the art that the above embodiment has been described by way of example only and not in any limitative sense, and that various alterations and modifications are possible without departure from the scope of the invention as defined by the appended claims.

What is claimed is:

1. A method for preventing BadUSB attack, comprising:
a) obtaining a device description from a USB (universal serial bus) device;
b) judging if the device description is reasonable;
c) loading a driver for the USB device when yes in step b);
d) filtering a command from the USB device after step c); and
e) disabling the USB device when no in step b) or the command filtered in step d) is malicious.

2. The method of claim 1, wherein the step b) is performed by comparing the device description with a black list database.

3. The method of claim 1, wherein the step d is performed by a USB layer firewall.

4. The method of claim 3, wherein the USB layer firewall is implemented by using a Filter driver.

5. The method of claim 1, wherein the step d) is performed by comparing the command with a malicious command database.
